(19) United States
(12) Patent Application Publication
(10) Pub. No.: US 2017/0272733 A1
(43) Pub. Date: Sep. 21, 2017

(54) IMAGE PROCESSING APPARATUS AND STEREOSCOPIC DISPLAY METHOD

(71) Applicant: HITACHI MEDICAL CORPORATION, Tokyo (JP)

(72) Inventors: Hiroki TANIGUCHI, Tokyo (JP); Shino TANAKA, Tokyo (JP)

(21) Appl. No.: 15/309,662

(22) PCT Filed: Apr. 17, 2015
(86) PCT No.: PCT/JP2015/061792

§ 371 Date: Nov. 8, 2016

(30) Foreign Application Priority Data
Jun. 3, 2014 (JP) 2014-114832

(51) Int. Cl. H04N 13/04; G06T 7/11; G06K 9/46; G06T 7/13; H04N 13/00; G06T 15/08

(52) U.S. Cl. CPC H04N 13/044; H04N 13/0011; H04N 13/0438; H04N 13/0459; H04N 13/0018; G06T 15/08; G06K 9/4604; G06T 7/13; G06T 7/11; G06T 2207/10012

(57) ABSTRACT

An image processing apparatus of the present invention includes a processing unit that calculates a first focal point position of a first parallax image group in the first attention region on the basis of the conditions including an attention region used to generate a stereoscopic image, generates the first parallax image group from the first focal point position by using volume data which is obtained from an image scanning apparatus, calculates a second focal point position which is located on a stereoscopic central line set when the first parallax image group is generated and which is the same depth direction position as a position of a point in the second attention region which is different from the first attention region, generates a second parallax image group from the second focal point position, and generates stereoscopic images by using the first parallax image group and the second parallax image group.

### TECHNICAL FIELD

The present invention falls into the category of control for machines of an image processing apparatus. The present invention falls into the category of a stereoscopic display method in a computer system. Specifically, the present invention relates to improvement of a technique of generating a stereoscopic image on the basis of medical image data.

### BACKGROUND ART

A stereoscopic display apparatus of the related art generates a stereoscopic image by using volume data of a medical image, and displays the stereoscopic image. Generally, stereoscopic display is roughly classified into two-parallax type display and multi-parallax type display using three or more parallaxes. In either type display, parallax images of the number corresponding to the number of necessary viewpoints are generated through a rendering process.

Meanwhile, in the stereoscopic display apparatus of the related art, a focus position of a stereoscopic image is set to be disposed at the center of the volume data. On the other hand, when a doctor such as a diagnostic reading doctor performs diagnosis with a medical image, in many cases, a region of interest is preferably rendered so as to be disposed at the center of the image. Thus, in a case where a region of interest set by a doctor and a medical worker (hereinafter, referred to as an “operator”) who assists the doctor in operations is located further toward the front side or the rear side in a depth direction than a focal point (origin) when viewed from a viewpoint of a stereoscopic image, the region of interest is not focused on.

In order to solve this problem, PTL 1 discloses a technique in which, if a user designates a focus position, a viewpoint or volume data is moved or rotated so that the focus position becomes a position of the origin (center), and thus a stereoscopic image (parallax image) is generated.

### CITATION LIST

### Patent Literature

PTL 1: JP-A-2013-39351

### SUMMARY OF INVENTION

### Technical Problem

However, an image processing system disclosed in PTL 1 generates a stereoscopic image by moving or rotating relative positions between the volume data and the viewpoint if the user designates the focus position.

Therefore, a stereoscopic image obtained after the focus position is changed is different from the image before the focus position is changed, in terms of a viewpoint or a visual angle, and a projection direction, and thus a display range may be changed. Even if the user desires to cause a region of interest to be focused on without changing a display range, a viewpoint, a direction, or the like, there is a case where the region of interest cannot be observed in a viewing way (a display range, a viewpoint, a visual angle, and a projection direction) desired by the user.

The present invention has been made in consideration of the above-described problems, and an object thereof is to provide an image processing apparatus and the like capable of performing stereoscopic display by causing a position of an attention region after being changed in a depth direction to be focused on without changing a display region, a viewpoint, or a projection direction of an original stereoscopic image even if the attention region in the stereoscopic image is changed.

### Solution to Problem

In order to achieve the above-described object, according to a first invention, there is provided an image processing apparatus including an input unit that receives setting of conditions including an attention region, a viewpoint position, a range of a stereoscopic space, and a rendering function used to generate a stereoscopic image, setting of a first attention region based on the conditions, and input values for setting a second attention region in a region which is different from the first attention region; and a processing unit that calculates a first focal point position of a first parallax image group in the first attention region on the basis of the conditions, generates the first parallax image group from the first focal point position by using volume data which is obtained from an image scanning apparatus, calculates a second focal point position which is located on a stereoscopic central line set when the first parallax image group is generated and which is the same depth direction position as a position of a point in the second attention region, generates a second parallax image group from the second focal point position, and generates stereoscopic images by using the first parallax image group and the second parallax image group.

According to a second invention, there is provided a stereoscopic display method of generating stereoscopic images by using a computer, the method including a step of causing a processing unit to acquire volume data obtained from an image scanning apparatus; a step of causing an input unit to set conditions for generating stereoscopic images; a step of setting an origin of a parallax image group in a predetermined attention region on the basis of the conditions set by the processing unit, and using a position of the origin as a first focal point position; a step of causing the processing unit to generate a first parallax image group by using the volume data so that the first focal point position is focused on; a step of causing the input unit to set a second attention region in a region which is different from the attention region; a step of causing the processing unit to calculate, as a second focal point position, a position of a point which is located on a stereoscopic central line set when the first parallax image group is generated and which has the same depth direction position as a position of a point in the second attention region; a step of causing the processing unit to generate a second parallax image group by using the volume data so that the second focal point position is focused on; and a step of causing the processing unit to perform stereoscopic image display control by using the first parallax image group or the second parallax image group.

### Advantageous Effects of Invention

According to the present invention, it is possible to provide an image processing apparatus and the like capable of performing stereoscopic display by causing a position of a changed region of interest in a depth direction to be focused on without changing a display region, a viewpoint, or a projection direction of an original stereoscopic image even if the region of interest in the stereoscopic image is changed.

### BRIEF DESCRIPTION OF DRAWINGS

FIG. 1 is a diagram illustrating the entire configuration of an image processing apparatus 100.

FIG. 2 is a diagram for explaining stereoscopic display and a parallax image group g1 (g1-1 and g1-2).

FIG. 3 is a diagram for explaining a viewpoint, a projection plane, a stereoscopic space, volume data, an attention region, and the like, in which FIG. 3(a) illustrates a case of parallel projection, and FIG. 3(b) illustrates a case of central projection.

FIG. 4 is a diagram illustrating a functional configuration of the image processing apparatus 100.

FIG. 5(a) is a diagram for explaining an original focal point (first focal point position F1), and FIG. 5(b) is a diagram for explaining a second focal point position F2 which is set after an attention region is changed.

FIG. 6 is a diagram for explaining an example in which a parallax image group is generated in a state in which a visual angle is fixed before and after an attention region is changed.

FIG. 7 is a flowchart illustrating the entire flow of a stereoscopic image display process.

FIG. 8 is a diagram for explaining a viewpoint, a projection plane, a stereoscopic space, volume data, an attention region, and the like when parallax images g1-1 and g1-2 are generated, in which FIG. 8(a) illustrates a case of parallel projection, and FIG. 8(b) illustrates a case of central projection.

FIG. 9 is a flowchart illustrating procedures of a stereoscopic image display process according to a second embodiment.

FIG. 10 is a flowchart illustrating procedures of a parallax image origin calculation process in step S204 in FIG. 10.

FIG. 11 illustrates examples of applying a rendering function to a voxel value (CT value) histogram of volume data.

FIG. 12 is a graph illustrating a linear CT value distribution crossing two regions.

FIG. 13 is a diagram illustrating candidate points f11 to f16 of focal points set at an edge of a region of interest ROI inside an attention region c1.

FIG. 14 is a flowchart illustrating procedures of a focal point position calculation process in step S210 in FIG. 10.

FIG. 15 is a flowchart illustrating procedures of a stereoscopic image display process according to a third embodiment.

FIG. 16 is a flowchart illustrating procedures of the stereoscopic image display process according to the third embodiment.

### DESCRIPTION OF EMBODIMENTS

Hereinafter, embodiments of the present invention will be described in detail with reference to the drawings.

### First Embodiment

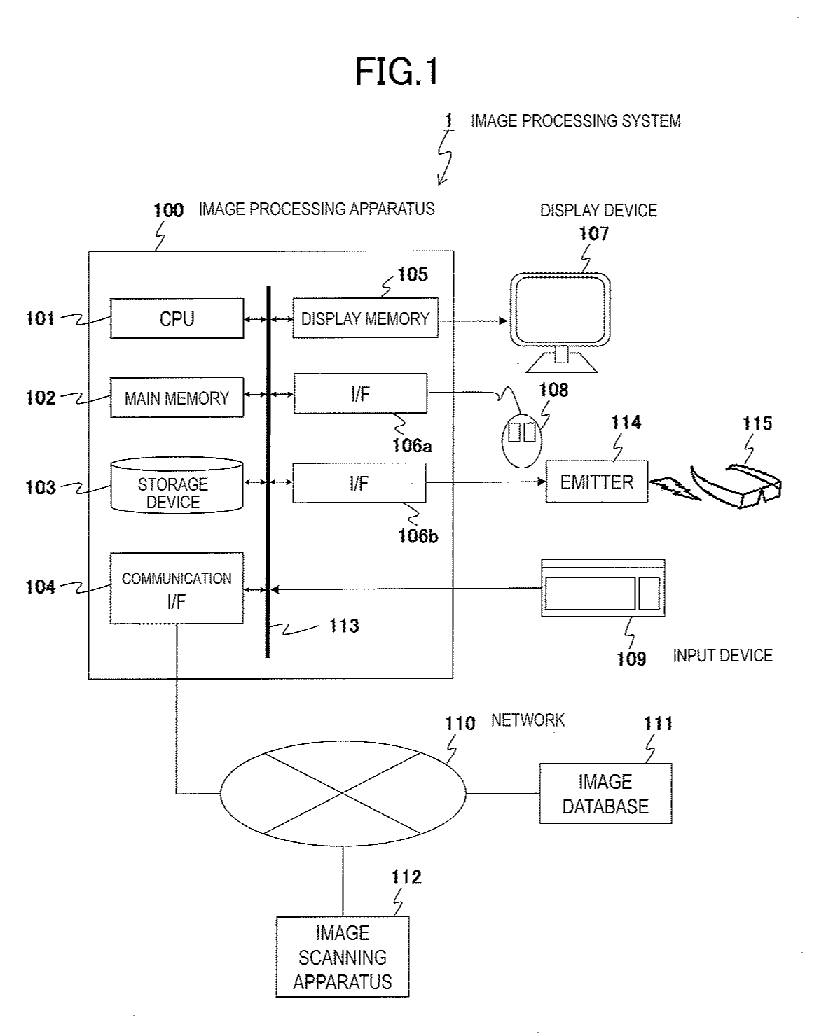

First, with reference to FIG. 1, a description will be made of a configuration of an image processing system 1 to which an image processing apparatus 100 of the present invention is applied.

As illustrated in FIG. 1, the image processing system 1 includes the image processing apparatus 100 provided with a display device 107 and an input device 109, an image database 111 connected to the image processing apparatus 100 via a network 110, and an image scanning apparatus 112.

The image processing apparatus 100 is a computer performing processes such as image generation and image analysis. As illustrated in FIG. 1, the image processing apparatus 100 includes a central processing unit (CPU) 101, a main memory 102, a storage device 103, a communication interface (communication I/F) 104, a display memory 105, and interfaces (I/Fs) 106a and 106b with external devices such as a mouse 108 and the like, and the respective constituent elements are connected to each other via a bus 113.

The CPU 101 calls a program stored in the main memory 102, the storage device 103 or the like to a work memory area of a RAM of the main memory 102, and executes the program, so as to control driving of the respective constituent elements connected to each other via the bus 113, and thus realizes various processes performed by the image processing apparatus 100.

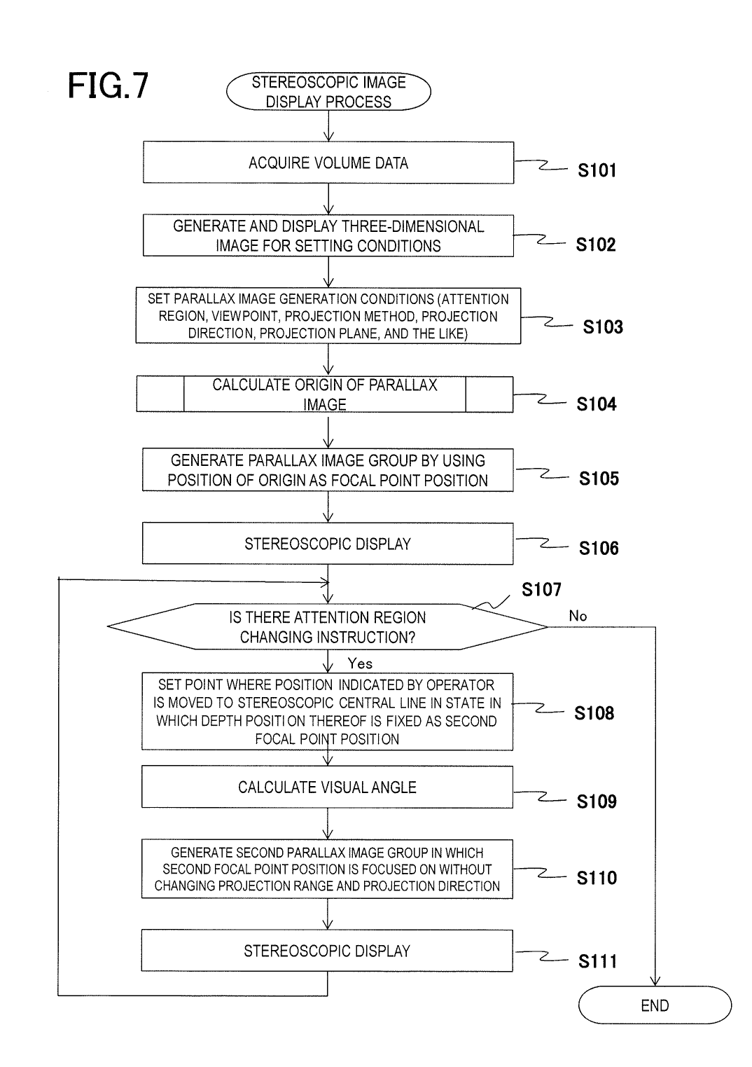

The CPU 101 performs a stereoscopic image display process (refer to FIG. 7) of generating a stereoscopic image by using volume data which is formed by piling up a plurality of slices of medical images, and displaying the stereoscopic image. Details of the stereoscopic image display process will be described later.

The main memory 102 is formed of a read only memory (ROM), a random access memory (RAM), and the like. The ROM eventually holds programs such as a boot program of the computer and BIOS, and data, for example. The RAM temporarily holds a program loaded from the ROM, the storage device 103 or the like, and data, and has a work area used for the CPU 101 to perform various processes.

The storage device 103 is a storage device reading and writing data from and to a hard disk drive (HDD) or other recording media, and stores programs executed by the CPU 101, data required to execute the programs, an operating system (OS), and the like. Regarding the programs, a control program corresponding to the OS, and application programs are stored. Each program code is read by the CPU 101 as necessary, and is transferred to the RAM of the main memory 102, so as to be executed as various means.

The communication I/F 104 is provided with a communication control device, a communication port, and the like, and relays communication between the image processing apparatus 100 and the network 110. The communication I/F 104 controls communication with the image database 111 or other computers, or the image scanning apparatus 112 such as an X-ray CT apparatus or an MRI apparatus, via the network 110.

The I/Fs (106a and 106b) are ports for connection with peripheral devices, and performs transmission and reception of data with the peripheral devices. For example, the image processing apparatus may be connected to a pointing device such as the mouse 108 or a stylus pen via the I/F 106a. In the first embodiment, the I/F 106b is connected to, for example, an infrared emitter 114 which transmits an operation control signal to shutter glasses 115.

The display memory 105 is a buffer which temporarily accumulates display data which is input from the CPU 101. The accumulated display data is output to the display device 107 at a predetermined timing.

The display device 107 is formed of a display device such as a liquid crystal panel or a CRT monitor, and a logic circuit which performs a display process in cooperation with the display device, and is connected to the CPU 101 via the display memory 105. The display device 107 displays the display data accumulated in the display memory 105 under the control of the CPU 101.

The input device 109 is an input device such as a keyboard, receives input values including various instruction or information which is input by the operator, and outputs the input values to the CPU 101. The operator operates the image processing apparatus 100 in an interactive manner by using the external devices such as the display device 107, the input device 109, and the mouse 108.

The network 110 includes various communication networks such as a local area network (LAN), a wide area network (WAN), an intranet, and the Internet, and mediates communication connection between the image database 111, a server, or other information apparatuses, and the image processing apparatus 100.

The image database 111 accumulates and stores image data scanned by the image scanning apparatus 112. In the image processing system 1 illustrated in FIG. 1, the image database 111 is configured to be connected to the image processing apparatus 100 via the network 110, but the image database 111 may be provided in, for example, the storage device 103 of the image processing apparatus 100.

The infrared emitter 114 and the shutter glasses 115 are devices which cause parallax images displayed on the display device 107 to be stereoscopically viewed. A device configuration for realizing stereoscopic view includes, for example, an active shutter glass type, a polarization type, a spectroscopic type, and an anaglyph type, and any type may be employed. The device configuration example (the infrared emitter 114 and the shutter glasses 115) illustrated in FIG. 1 illustrates an active shutter glass type device configuration example.

When the display device 107 is used as a stereoscopic monitor, a right eye parallax image and a left eye parallax image are alternately displayed in a switching manner. The shutter glasses 115 alternately block the right eye and left eye visual fields in synchronization with a switching timing of parallax images displayed on the stereoscopic monitor. The infrared emitter 114 transmits a control signal for synchronizing the stereoscopic monitor with the shutter glasses 115, to the shutter glasses 115. A left eye parallax image and a right eye parallax image are alternately displayed on the stereoscopic monitor, the shutter glasses 115 block the right eye visual field during display of the left eye parallax image on the stereoscopic monitor, and the shutter glasses 115 block the left eye visual field during display of the right eye parallax image on the stereoscopic monitor. As mentioned above, the images displayed on the stereoscopic monitor are switched in interlocking with states of the shutter glasses 115, and thus afterimages remain on both eyes of an observer so as to be viewed as stereoscopic images.

As a stereoscopic monitor, there is a stereoscopic monitor which allows an observer to stereoscopically view multi-parallax images using three or more parallaxes with the naked eyes by using a light beam controller such as a lenticular lens. Such a kind of stereoscopic monitor may be used as the display device of the image processing apparatus 100 of the present invention.

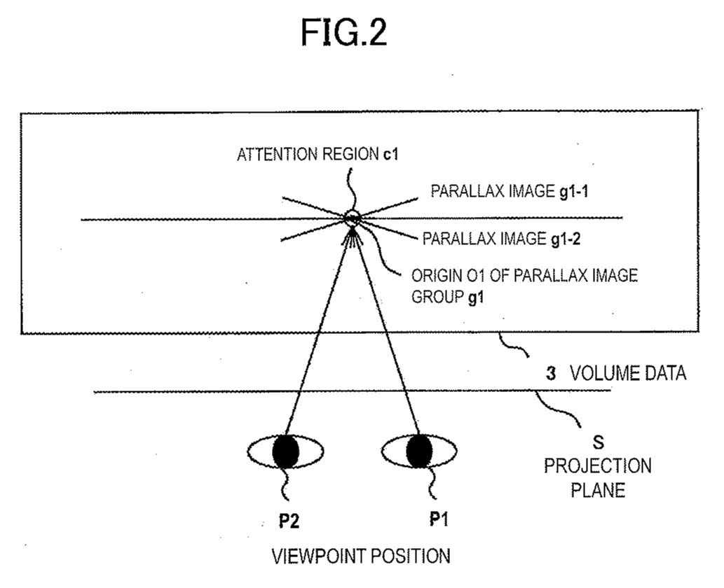

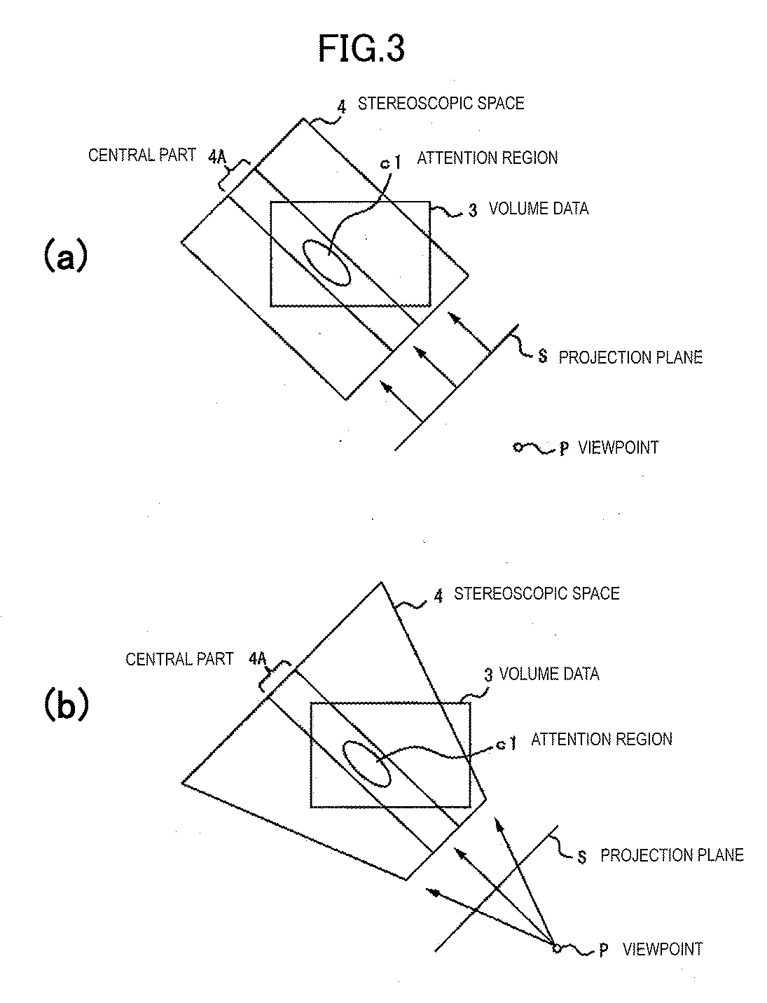

Here, with reference to FIGS. 2 and 3, stereoscopic display and a parallax image will be described.

The parallax image is an image generated by moving a viewpoint position by a predetermined visual angle (also referred to as a parallax angle) and performing a rendering process with respect to processing target volume data. In order to perform stereoscopic display, parallax images corresponding to the number of parallaxes are required. In a case where the stereoscopic display is performed by using binocular parallax, as illustrated in FIG. 2, the number of parallaxes is two. In a case where the number of parallaxes is two, a parallax image g1-1 for the right eye (viewpoint P1) and a parallax image g1-2 for the left eye (viewpoint P2) are generated.

The visual angle is an angle defined by positions of the adjacent viewpoints P1 and P2, and a focal point position (for example, an origin O1 in FIG. 2).

The number of parallaxes is not limited to two, and may be three or more.

FIG. 3 is a diagram for explaining a viewpoint P, a projection plane S, volume data 3, a stereoscopic space 4, an attention region c1, and the like, in which FIG. 3(a) illustrates a case of parallel projection, and FIG. 3(b) illustrates a case of central projection. In FIG. 3, arrows indicate rendering projection lines.

In a case where the predetermined attention region c1 in the volume data 3 is rendered through a rendering process, the stereoscopic space 4 which includes the attention region c1 and is enlarged in a depth direction when viewed from the viewpoint P is set. In a case where a parallax image is generated according to a parallel projection method, as illustrated in FIG. 3(a), the viewpoint P is assumed to be located at infinity, and the respective projection lines which are directed toward the stereoscopic space 4 from the viewpoint P are parallel to each other. On the other hand, in a central projection method, as illustrated in FIG. 3(b), projection lines are set in a radial form from the predetermined viewpoint P.

The example illustrated in FIG. 3 shows a state in which the viewpoint P, the projection plane S, and the stereoscopic space 4 are set so that the attention region c1 comes to the center of the stereoscopic space in either case of the parallel projection method and the central projection method. The operator may set any viewpoint P (indicating from which direction observation is performed) at which the attention region c1 in the volume data 3 and a single region of interest or a plurality of regions of interest (not illustrated) present in the attention region c1 can be observed.

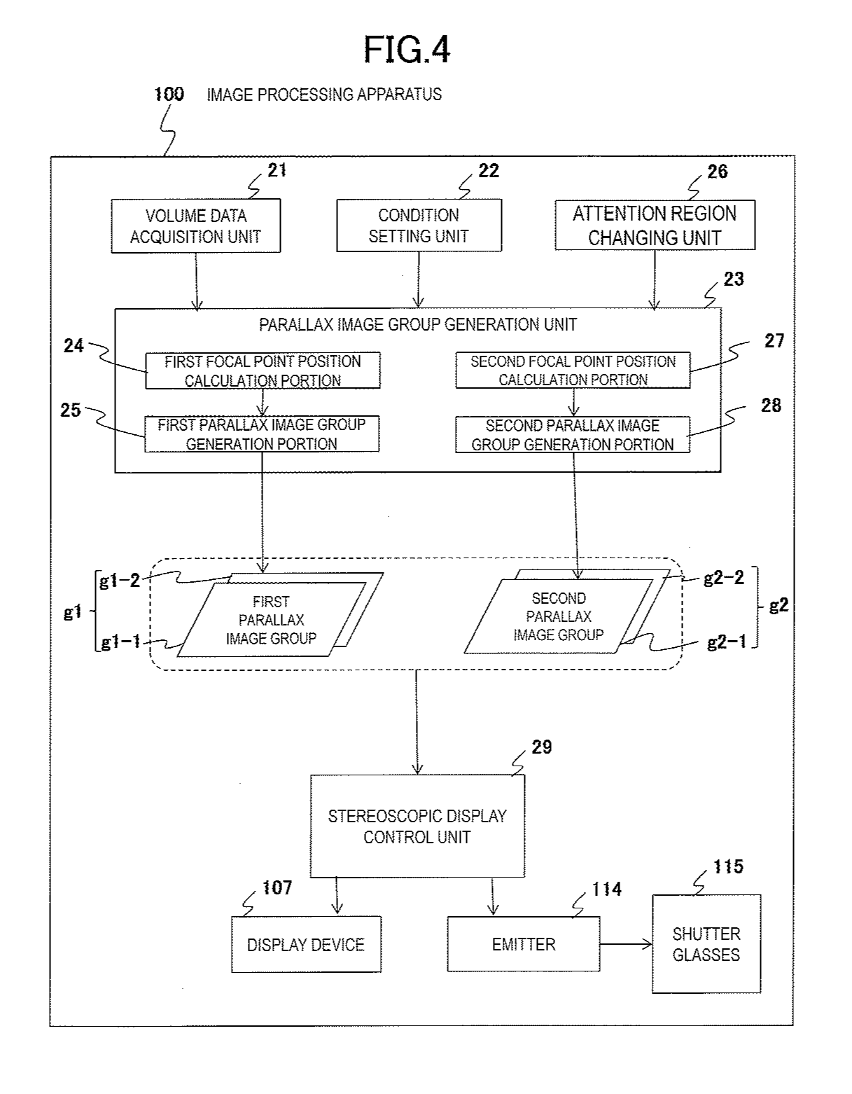

Next, with reference to FIG. 4, a functional configuration of the image processing apparatus 100 will be described.

As illustrated in FIG. 4, the image processing apparatus 100 includes a volume data acquisition unit 21, a condition setting unit 22, a parallax image group generation unit 23, an attention region changing unit 26, and a stereoscopic display control unit 29.

The volume data acquisition unit 21 acquires the volume data 3 of a medical image as a processing target from the storage device 103, the image database 112, or the like. The volume data 3 is image data obtained by piling up a plurality of tomographic images of an object scanned by using a medical image scanning apparatus such as an X-ray CT apparatus or an MR apparatus. Each voxel of the volume data 3 has density value (CT value) data of a CT image or the like.

The condition setting unit 22 sets conditions for generating a parallax image group. The conditions are the attention region c1, a projection method (parallel projection or central projection), the viewpoint P, the projection plane S, a projection direction, a range of the stereoscopic space 4, a rendering function, and the like. The condition setting unit 22 is preferably provided with a user interface for inputting, displaying, and editing the above-described respective conditions.

The parallax image group generation unit 23 includes a first focal point position calculation portion 24 and a first parallax image group generation portion 25 for generating a first parallax image group g1 in which the attention region c1 set by the condition setting unit 22 is focused on; a second focal point position calculation portion 27 which calculates a second focal point position which is set according to a change of the attention region; and a second parallax image group generation portion 28 which generates a parallax image group g2 in which the second focal point position calculated by the second focal point position calculation portion 27 is focused on.

The first focal point position calculation portion 24 disposes the attention region c1 of the volume data 3 at a central part 4A of the stereoscopic space 4 on the basis of conditions set by the condition setting unit 22, and sets a certain point in the attention region c1 as an origin O1. The origin O1 is used as a focal point (first focal point position F1) in a case where the attention region c1 is observed.

The first parallax image group generation portion 25 generates the first parallax image group g1 so that the first focal point position calculated by the first focal point position calculation portion 24 is focused on. In a case where the number of viewpoints is two, the first parallax image group g1 is generated as two parallax images g11-1 and g1-2 as illustrated in FIG. 2. The parallax image g1-1 is obtained by performing a rendering process on the volume data 3 from a viewpoint P1 with the first focal point position F1 as the center (origin O1) of the image and projecting the volume data onto a projection plane S1. The parallax image g1-2 is obtained by performing a rendering process on the volume data including the attention region c1 from a viewpoint P2 with the first focal point position F1 as the center (origin O1) of the image and projecting the volume data onto the projection plane S1.

Also in a case where the number of viewpoints is two or more (the number of parallaxes is two or more), parallax images generated so that the origin O1 becomes a focal point are generated by the number of parallaxes in the same manner as in a case where the number of viewpoints is two. In the following description, the respective parallax images g1-1, g1-2, . . . generated by setting the focal point F1 in the attention region c1 are collectively referred to as the parallax image group g1.

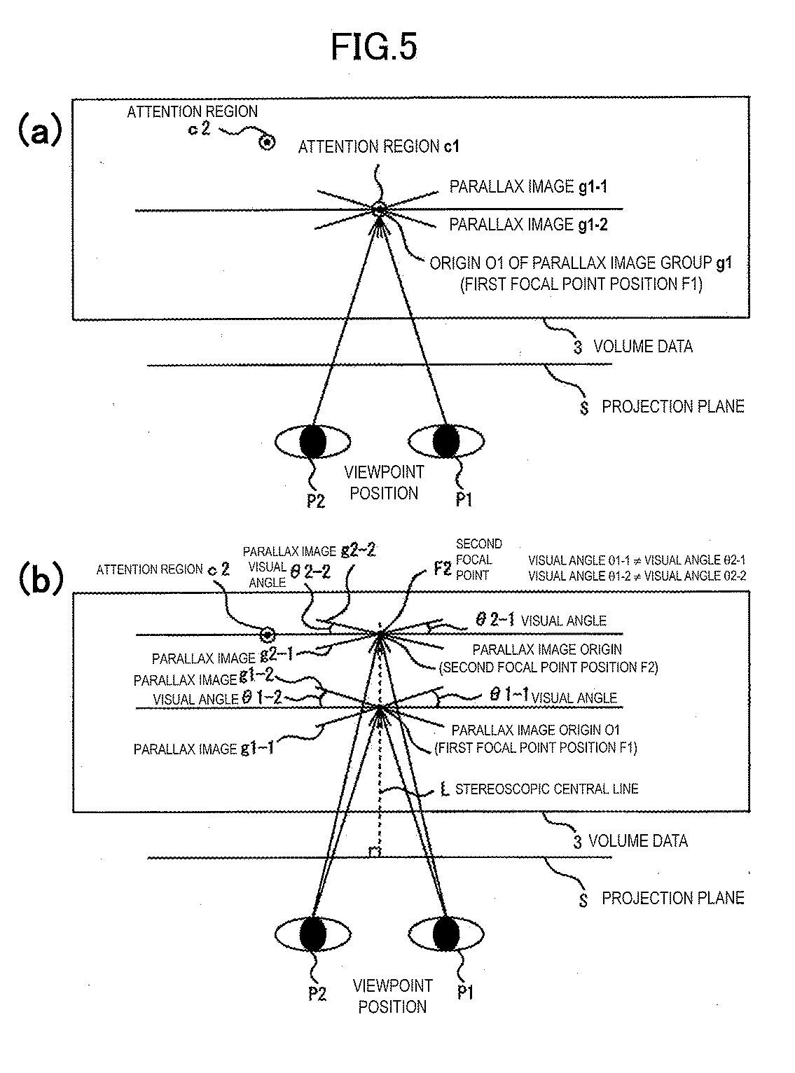

The attention region changing unit 26 sets a second attention region c2 in a region which is different from the attention region c1 for generating the first parallax image group g1 (refer to FIG. 5(a)). The attention region changing unit 26 is preferably provided with a user interface used to change an attention region.

Preferably, the user interface of the attention region changing unit 26 generates and displays, for example, a three-dimensional image or the like which is shaded by performing a volume rendering process on the volume data 3 so that a region of interest is displayed, and allows a desired three-dimensional position in the volume data 3 to be indicated by a pointing device or the like by rotating the three-dimensional image or moving the image in parallel through the operator's operation on the input device 109 or the mouse 108.

The second focal point position calculation portion 27 calculates a second focal point position F2 corresponding to a focal point position after the attention region is changed. The second focal point position F2 is a point which is located on a stereoscopic central line L when the first parallax image group g1 is generated, and whose depth direction position is the same as a depth direction position of the attention region c2 after being changed. The stereoscopic central line L is a perpendicular line which extends to the first focal point position F1 from the projection plane S.

As illustrated in FIG. 5(a), if the second attention region c2 is set at a position which is different from the position of the attention region c1, as illustrated in FIG. 5(b), the second focal point position calculation portion 27 sets the second focal point F2 to a point which is located at the same depth direction position as that of the second attention region c2 and is located on the stereoscopic central line L. In a case where the attention region c2 is wide, a representative point present in the second attention region c2 is determined, and the second focal point F2 is set to a point which is located at the same depth direction position as that of the representative point and is located on the stereoscopic central line L. The representative point is preferably a point which is easily extracted and is suitable for diagnosis using a medical image, such as an edge part of a region of interest present in the attention region.

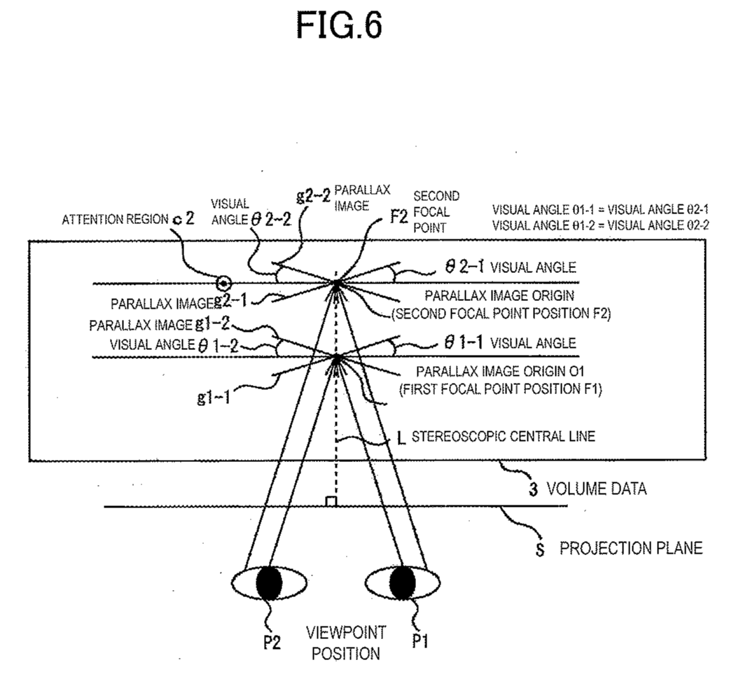

The second parallax image group generation portion 28 generates the second parallax image group g2 so that the second focal point position F2 calculated by the second focal point position calculation portion 27 is focused on. Visual angles θ2-1 and θ2-2 of the second parallax image group g2 may be the same as those of the first parallax image group g1 (visual angle fixation; refer to FIG. 6), and may be determined on the basis of a distance between the second focal point position F2 and each of the viewpoints P1 and P2 (visual angle changing; refer to FIG. 5(b)).

In a case where a visual angle is fixed, a viewpoint position is finely adjusted on the basis of a focal point position and a preset visual angle. An example of visual angle fixing will be described later (third embodiment). In a case where a visual angle is changed, the visual angles θ2-1 and θ2-2 of the second parallax image group g2 are different from visual angles θ1-1 and θ1-2 of the first parallax image group g1. The second parallax image group generation portion 28 stores the generated second parallax image group g2 in the main memory 102 or the storage device 103.

Whether a visual angle is fixed or changed is preferably arbitrarily selected by the operator when conditions are set. A visual angle may be set while a stereoscopic image is being checked. Visual angle setting will be described in the third embodiment.

The stereoscopic display control unit 29 reads the first parallax image group g1 or the second parallax image group g2 from the main memory 102 or the storage device 103, and performs stereoscopic image display control thereon. In the stereoscopic image display control, the stereoscopic display control unit 29 alternately switches and displays the right eye disparity image g1-1 and the left eye disparity image g1-2 of the read parallax images on the display device 107. A signal for switching a polarization operation of the shutter glasses 115 is sent to the emitter 114 in synchronization with a display switching timing of the display device 107. The parallax image group g1 or g2 can be stereoscopically viewed as a result of viewing the parallax images via the shutter glasses 115.

Next, with reference to a flowchart of FIG. 7, a description will be made of a flow of the stereoscopic image display process performed by the image processing apparatus 100 according to the first embodiment.

The CPU 101 acquires processing target volume data of medical images from the storage device 103 or the image database 111 connected thereto via the communication I/F 104 (step S101). The CPU 101 generates a three-dimensional image for setting conditions, and displays the image on the display device 107 (step S102). For example, in a case where a blood vessel is an observation part, a volume rendering image obtained by extracting a blood vessel region from the volume data acquired in step S101 and rendering the blood vessel region is generated, and is displayed as the three-dimensional image for setting conditions on the display device 107.

Next, the CPU 101 performs a condition setting process for generating parallax images (step S103). In the condition setting process in step S103, a position where the attention region c1 is observed (the viewpoints P1 and P2, a projection method (parallel projection or central projection), a projection direction, the projection plane S1, the attention region c1, and the like), a rendering function, a range of the stereoscopic space 4 and the like are set. In the condition setting process, for example, it is preferable to generate and display an operation screen (user interface) on which a position of the attention region c1 or a region of interest can be indicated by the operator with a pointing device or the like while rotating the three-dimensional image for setting conditions displayed in step S102 or moving the image in parallel.

The CPU 101 calculates the origin O1 of the first parallax image group g1 on the basis of the conditions set in step S102 (step S104). The CPU 101 calculates the origin O1 of the first parallax image group g1 so that a point in the attention region c1 is located at the central part 4A of the stereoscopic space 4 regardless of the projection method (parallel projection or the central projection).

The point in the attention region c1 set as the origin O1 may be located at a three-dimensional position designated by the operator with a pointing device or the like, and may be calculated automatically by the CPU 101 on the basis of a predetermined condition. In a case where the origin O1 is calculated automatically, the CPU 101 sets a point which is present in the attention region c1 and satisfies a predetermined rendering condition, as the origin O1.

For example, in a case where a blood vessel region is rendered, coordinates having pixel values of the blood vessel region are obtained by using a profile (histogram) regarding density values of the volume data, and are used as candidate points of the origin O1. In a case where there are a plurality of candidate points of the origin O1, the operator selects an optimal point among the plurality of candidate points as the origin O1. Alternatively, a point satisfying a predetermined condition may be selected as an optimal point from among the plurality of candidate points, and the point may be set as the origin O1. Details of methods of calculating the origin O1 automatically will be described in a second embodiment.

The CPU 101 generates the first parallax image group g1 by using the position of the origin O1 calculated in step S104 as the first focal point position F1 (step S105).

In the process of generating the first parallax image group g1, first, the CPU 101 acquires a rendering function which can render a preset region of interest, from the storage device 103. A rendering process is performed on the basis of the conditions (the projection method, the viewpoint, the projection direction, the projection plane, the stereoscopic space (projection range) and the like) set in step S102 in FIG. 6 by using the acquired rendering function.

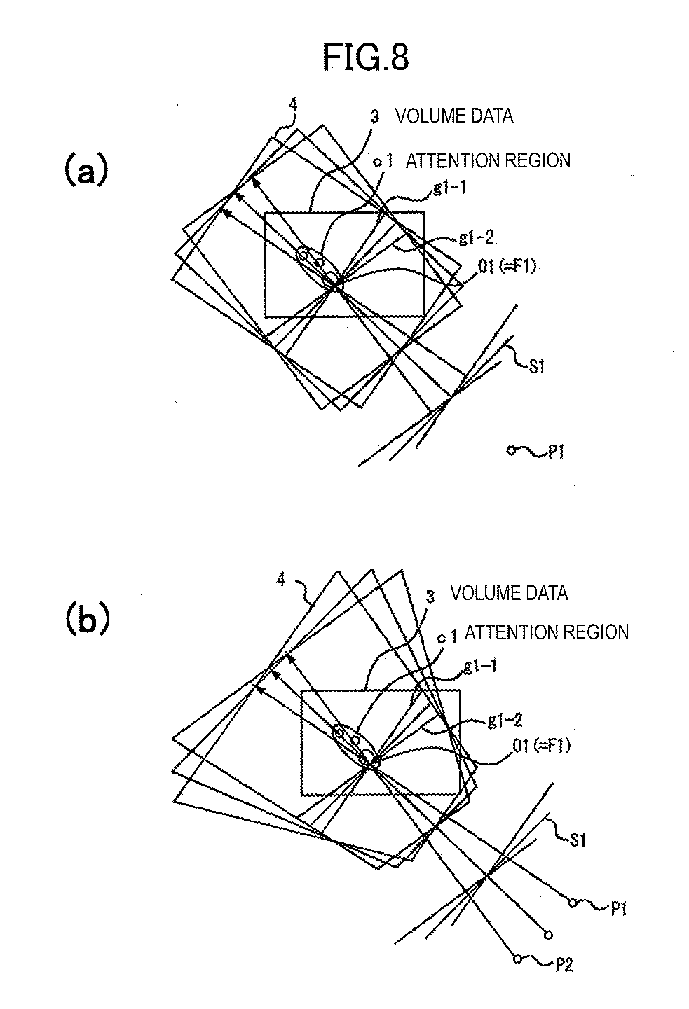

FIG. 8(a) illustrates a case where the parallax images g1-1 and g1-2 are generated according to the parallel projection method, and FIG. 8(b) illustrates a case where the parallax images g1-1 and g1-2 are generated according to the central projection method.

In the parallel projection method, as illustrated in FIG. 8(a), a plurality of parallel projection lines are set in the volume data 3, and a rendering process is performed by using a predetermined rendering function. A rendering process result of each projection line is projected onto the projection plane S1, and thus the parallax image g1-1 is obtained. Regarding the parallax image g1-2, projection lines which are inclined by a visual angle θ relative to the projection lines of the parallax image g1-1 are set, the origin O1 is set to be the same as the origin O1 of the parallax image g1-1, and a rendering process is performed on the volume data 3 by using the above-described rendering function. A rendering process result of each projection line is projected onto the projection plane S1, and thus the parallax image g1-2 is obtained.

In the central projection method, as illustrated in FIG. 8(b), a plurality of projection lines are set in the volume data in a radial shape from the viewpoint P1, and a rendering process is performed by using a predetermined rendering function. A rendering process result of each projection line is used as a pixel value of the projection plane S1, and thus the parallax image g1-1 is generated. Regarding the parallax image g1-2, projection lines which are inclined with respect to the projection line of the parallax image g1-1 by a visual angle θ which is set on the basis of positional relationships between the two viewpoints P1 and P2 and the focal point position F1 are set, and a rendering process is performed by using the above-described rendering function. A rendering process result of each projection line is used as a pixel value of the projection plane S2, and thus the parallax image g1-2 is generated.

If the first parallax image group g1 (parallax images g1-1 and g1-2) is generated in step S105 in FIG. 7, the CPU 101 performs stereoscopic display by using the generated parallax images g1-1 and g1-2 (step S106). In the stereoscopic display in step S106, the CPU 101 alternately displays the parallax images g1-1 and g1-2 on the display device 107, and sends a control signal which is synchronized with a display switching timing, to the shutter glasses 115 via the emitter 114.

The shutter glasses 115 switch light blocking timings for the left eye and the right eye in response to the control signal transmitted from the emitter 114. Consequently, an afterimage of the other parallax image remains during display of one parallax image, and thus stereoscopic view is realized.

Then, if a three-dimensional position of the volume data is indicated with a pointing device or the like, and thus the new attention region c2 is set (Yes in step S107), the CPU 101 sets a position of a point which is moved to the stereoscopic central line L in a state in which a depth position of the position indicated by the operator is fixed, as the second focal point position F2 (step S108). The CPU 101 sets a visual angle. For example, in a case where a visual angle is set to be changed depending on a focal point position in advance, the CPU 101 obtains a new visual angle on the basis of positional relationships between the second focal point position F2 and the respective viewpoints P1 and P2 (step S109), and generates the second parallax image group g2 without changing the projection method, the projection range, and the projection direction (step S110). The CPU 101 performs stereoscopic display by using the generated second parallax image group g2 (step S111).

The focal point position (second focal point position F2) after the attention region is changed is moved not to the designated attention region c2 but to the same depth direction position as that of the attention region c2 on the stereoscopic central line L, but stereoscopic images are displayed in the same range and from the same direction as those of the stereoscopic images based on the first parallax image group g1.

In the method of the related art, the origin of a parallax image is moved so that a attention region after being changed is focused on, and thus an observation range of the image or a projection direction is also changed from the previous image, but, according to the present invention, only a depth direction position of a focal point is changed in a state in which a range and a direction desired to be observed by an observer are fixed even after an attention region is changed. As a result, an image in which a location close to the attention region after being changed is focused on can be displayed. For example, in a case where a certain point in a blood vessel region is set as a region of interest, the region of interest may be hidden due to meandering of a blood vessel if a projection direction or a projection range is changed, but, according to the present invention, since a projection direction or a projection range is maintained in an original state, it is possible to observe a stereoscopic image in which a focal point is moved to a depth direction position of another attention region while being capable of observing the original region of interest.

The processes in steps S108 to Sill are repeatedly performed whenever an instruction for changing the attention region is input (Yes in step S107). In a case where the attention region is not changed (No in step S107), a series of stereoscopic image display processes are finished.

As described above, the image processing apparatus 100 of the first embodiment includes the input unit (input device) 109 receiving setting of conditions including an attention region, a viewpoint position, a range of the stereoscopic space, and a rendering function, used for generation of stereoscopic images, setting of a first attention region based on the conditions, and input values for setting a second attention region in a region which is different from the first attention region; and a processing unit (CPU) 101 calculating a first focal point position of a first parallax image group in the first attention region on the basis of the conditions, generating the first parallax image group from the first focal point position by using volume data which is obtained from the image scanning apparatus 112, calculating a second focal point position which is located on a stereoscopic central line set when the first parallax image group is generated and which is the same depth direction position as that of a point in the second attention region, generating a second parallax image group from the second focal point position, and generating stereoscopic images by using the first parallax image group and the second parallax image group.

In other words, the image processing apparatus 100 of the first embodiment includes the condition setting unit 22 that sets conditions for generating stereoscopic images by using volume data obtained from the image scanning apparatus 112; the first focal point position calculation portion 24 that sets an origin of a parallax image group in a predetermined attention region on the basis of the conditions set by the condition setting unit 22, and uses a position of the origin as a first focal point position; the first parallax image group generation portion 25 that generates a first parallax image group by using the volume data so that the first focal point position is focused on; the attention region changing unit 26 that sets a second attention region in a region which is different from the attention region; the second focal point position calculation portion 27 that calculates, as a second focal point position, a position of a point which is located on a stereoscopic central line set when the first parallax image group is generated and which has the same depth direction position as that of a point in the second attention region set by the attention region changing unit 26; the second parallax image group generation portion 28 that generates a second parallax image group by using the volume data so that the second focal point position is focused on; and the stereoscopic display control unit 29 that performs stereoscopic image display control by using the first parallax image group or the second parallax image group.

As an example, a stereoscopic display method of operating the image processing apparatus 100 of the first embodiment is a stereoscopic display method of generating stereoscopic images by using a computer or the like, and includes a step of causing the CPU 101 to acquire volume data obtained from the image scanning apparatus 112; a step of causing an input unit to set conditions for generating stereoscopic images; a step of setting an origin of a parallax image group in a predetermined attention region on the basis of the conditions set by the processing unit, and using a position of the origin as a first focal point position; a step of causing the processing unit to generate a first parallax image group by using the volume data so that the first focal point position is focused on; a step of causing the input unit to set a second attention region in a region which is different from the attention region; a step of causing the processing unit to calculate, as a second focal point position, a position of a point which is located on a stereoscopic central line set when the first parallax image group is generated and which has the same depth direction position as that of a point in the second attention region; a step of causing the processing unit to generate a second parallax image group by using the volume data so that the second focal point position is focused on; and a step of causing the processing unit to perform stereoscopic image display control by using the first parallax image group or the second parallax image group.

According to the image processing apparatus 100 of the first embodiment, if stereoscopic images (parallax images) are temporarily generated so that a certain attention region (first attention region) c1 is focused on, and then the first attention region is changed, the second parallax image g2 is generated so that a point (second focal point position) which is located at the same depth direction position as that of the second attention region c2 after being changed and is moved to the stereoscopic central line L of the first parallax image group g1 is focused on, instead of focusing on the second attention region c2 after being changed. The second parallax image g2 has, for example, the same projection direction or projection range as that of the original images (first parallax image group). Therefore, it is possible to observe a stereoscopic image in which a focal point is moved to the depth direction position of another second attention region c2 while the original first attention region c1 is included in a visual field.

The image processing apparatus 100 of the first embodiment may be characterized in that a three-dimensional position of the volume data is further designated via the input device 109 or the mouse 108, and the CPU 101 designates a point in the second attention region by using the three-dimensional position.

As mentioned above, if a point in the second attention region is designated at a three-dimensional position, options of movement directions of a parallax image can be increased compared with a case of designating changing points of the first attention region and the second attention region.

The image processing apparatus 100 of the first embodiment may be characterized in that the CPU 101 extracts a region of interest from the second attention region, calculates at least one representative point of the extracted region of interest, and uses, as candidate points for the second focal point position, respective points which are located on the stereoscopic central line set when the first parallax image group is generated and are located at the same depth direction position as that of each of the representative points.

As mentioned above, if a representative point present in the second attention region c2 is determined, the second focal point F2 is set to a point which is located at the same depth direction position as that of the representative point and is located on the stereoscopic central line L, and thus it is possible to promptly set a focal point position even if the second attention region c2 is wide.

The image processing apparatus 100 of the first embodiment may be characterized in that the CPU 101 extracts the region of interest on the basis of a profile regarding voxel values of the volume data and a rendering condition.

As mentioned above, the CPU 101 sets the point which is present in the attention region c1 and satisfies a predetermined rendering condition as the origin O1, and thus it is possible to omit a complicated operation performed by the operator.

The image processing apparatus 100 of the first embodiment may be characterized in that the CPU 101 calculates an edge part of the region of interest as the representative point.

As mentioned above, the edge part of the region of interest is used as the representative point, and thus image diagnosis is not influenced, for example, since a central part of the region of interest is not used as the representative point.

The image processing apparatus 100 of the first embodiment may be characterized that the main memory 102 or the storage device 103 which stores parallax image groups generated with respect to candidate points for the second focal point position is further provided, an instruction for switching the candidate points is input via the input device 109 or the mouse 108, and the CPU 101 reads parallax image groups for different candidate points from the main memory 102 or the storage device 103 in response to the instruction, and sequentially switches the parallax image groups so as to perform stereoscopic display.

As mentioned above, focal point positions are sequentially switched and displayed in response to an instruction from the operator, and thus the operator can determine a focal point position while checking a difference in a viewing way.

The image processing apparatus 100 of the first embodiment may be characterized in that the CPU 101 generates the second parallax image group at the same visual angle as a visual angle set when the first parallax image group is generated.

The image processing apparatus 100 of the first embodiment may be characterized in that the CPU 101 generates the second parallax image group at a visual angle corresponding to a positional relationship between the second focal point position and each viewpoint position.

As mentioned above, since the second parallax image group is generated at the same visual angle as a visual angle set when the first parallax image group is generated, or the second parallax image group is generated at a visual angle corresponding to a positional relationship between the second focal point position and each viewpoint position, setting of a visual angle is omitted when the second parallax image group is generated, and thus the number of operations by the operator operating the input device 109 or the mouse 108 can be reduced, which contributes to improvement of operability.

### Second Embodiment

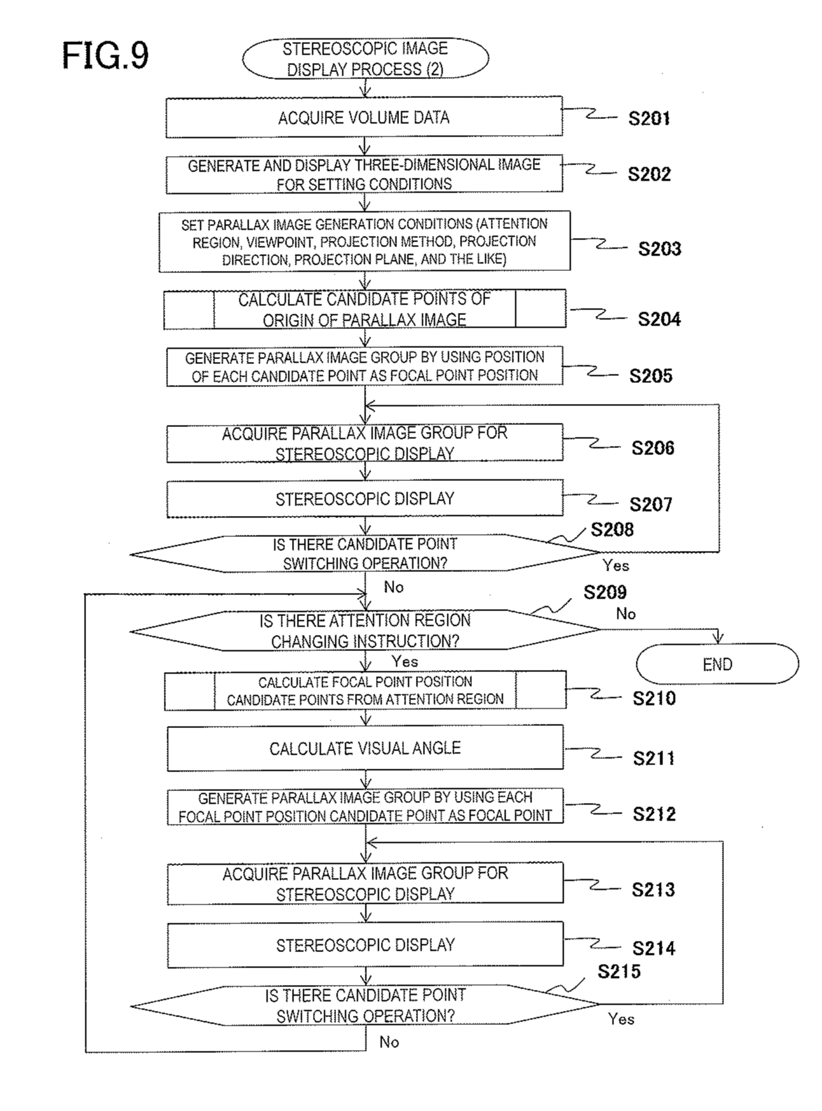

Next, a second embodiment of the present invention will be described with reference to FIGS. 9 to 14.

In the image processing apparatus 100 of the second embodiment, the CPU 101 automatically calculates a focal point position of a parallax image group.

In a condition setting step or an attention region changing step, in a case where an attention region is designated according to an operation method of indicating a three-dimensional image for setting conditions on an operation screen, vertical and horizontal positions (two-dimensional position) on the screen can be indicated, but a depth direction position cannot be uniquely specified. For example, in a case where a blood vessel region is observed, if blood vessels are present so as to overlap each other in a depth direction at a two-dimensional position indicated by the operator, it cannot be specified which blood vessel is used as an attention region. Therefore, in the second embodiment, a description will be made of a preferable method of determining a focal point position.

A hardware configuration of the image processing apparatus 100 of the second embodiment and a functional configuration except for the parallax image group generation unit 23 are the same as those of the image processing apparatus 100 (refer to FIGS. 1 and 4) of the first embodiment, and thus repeated description will be omitted.

FIG. 9 is a flowchart illustrating the entire flow of a stereoscopic image display process (2).

Steps S201 to S203 are the same as in the first embodiment. The CPU 101 acquires the processing target volume data 3 of medical images from the image database 111 (step S201), generates a three-dimensional image for setting conditions, and displays the image on the display device 107 (step S202). The operator sets conditions for generating parallax images while rotating the three-dimensional image for setting conditions or moving the image in parallel (step S203). The conditions include an attention region, a viewpoint position, a range of a stereoscopic space, a rendering function, and the like.

Next, the CPU 101 calculates candidate points of the origin of the first parallax image group g1 on the basis of the conditions set in step S202 (step S204). In step S204, the CPU 101 calculates a plurality of candidate points of the origin O1 of the first parallax image group g1 from the inside of the attention region c1. The parallax image origin calculation process in step S204 will be described later in detail.

By using the respective candidate points of the origin O1 calculated in step S204 as focal point positions f11, f12, f13, . . . , the CPU 101 generates parallax image groups g11, g12, g13, . . . in which the focal point positions f11, f12, f13, . . . are respectively focused on (step S205). The parallax image group g11 includes a parallax image g11-1, a parallax image g11-2, . . . having the candidate point f11 as a focal point. Similarly, the parallax image group g12 includes a parallax image g12-1, a parallax image g12-2, . . . having the candidate point f12 as a focal point, and the parallax image group g13 includes a parallax image g13-1, a parallax image g13-2, . . . having the candidate point f13 as a focal point. The CPU 101 stores the generated parallax image groups g11, g12, g13, . . . in the main memory 102 or the storage device 103.

The CPU 101 reads a single parallax image group among the plurality of generated parallax image groups g11, g12, g13, . . . (step S206), and performs stereoscopic display (step S207). For example, a parallax image group having a focal point position which is nearest to the viewpoint is acquired among the plurality of parallax image groups, and the stereoscopic display is performed.

If a candidate point switching operation is input (Yes in step S208), the CPU 101 acquires another parallax image group (step S206), and performs stereoscopic display (step S207). In step S208, for example, a parallax image group having the second nearest focal point position to the viewpoint is acquired, and stereoscopic display is performed. As mentioned above, whenever the candidate point switching operation is input (Yes in step S208), the CPU 101 reads a parallax image group at the next depth direction position from the main memory 102 or the storage device 103, and performs stereoscopic display. Since focal point positions are switched and displayed in response to an instruction from the operator, the operator can determine a focal point position while checking a difference in a viewing way.

In a case where an attention region changing instruction is input (Yes in step S209), the CPU 101 calculates candidate points for a new focal point position from the inside of an attention region after being changed (step S210).

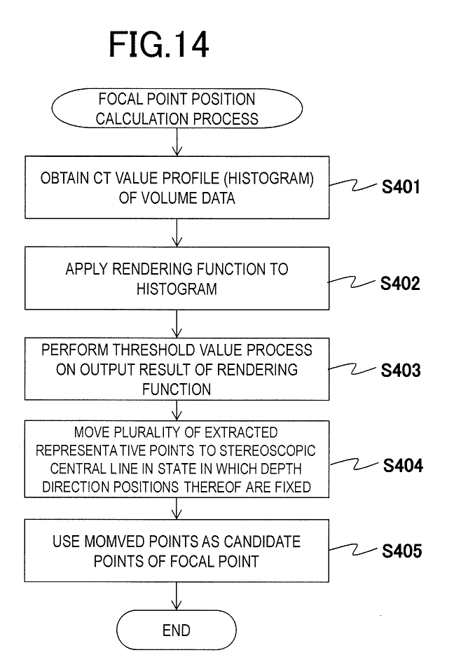

A process of calculating candidate points for a focal point position will be described later (refer to FIG. 14).

The CPU 101 sets a visual angle after the attention region is changed (step S211). In the same manner as in the first embodiment, a visual angle may be set according to a visual angle fixation method (the same visual angle as the visual angle when the parallax image is generated in step S205 is used), and may be set according to a visual angle changing method (a viewpoint position is the same as that of an original stereoscopic image, and a visual angle is calculated depending on a difference between the viewpoint and a focal point). In step S211, in a case where a visual angle is changed, the CPU 101 calculates a visual angle for each of candidate points for a second focal point position. On the other hand, in a case where a visual angle is fixed, the same visual angle as the visual angle set when the parallax image group is generated in step S205 is set.

The CPU 101 generates parallax image groups g21, g22, g23, . . . with respect to the respective candidate points for the second focal point position calculated in step S210 by using the visual angle set in step S211 (step S212). The CPU 101 stores the generated parallax image groups g21, g22, g23, . . . in the main memory 102 or the storage device 103.

The CPU 101 acquires a single parallax image group among the plurality of parallax image groups g21, g22, g23, . . . generated for the attention region after being changed (step S213), and performs stereoscopic display (step S214). For example, a parallax image group having a focal point position which is nearest to the viewpoint is acquired among the plurality of parallax image groups g21, g22, g23, . . . after the attention region is changed, and the stereoscopic display is performed.

If a candidate point switching operation is input (Yes in step S215), the CPU 101 acquires another parallax image group among the parallax image groups g21, g22, g23, . . . generated in step S212 (step S213), and performs stereoscopic display (step S214). For example, a parallax image group having a focal point position in the attention region c2, which is second nearest to the viewpoint, is acquired, and stereoscopic display is performed. As mentioned above, whenever the candidate point switching operation is input (Yes in step S215), the CPU 101 reads a parallax image group having the next depth direction position as a focal point position from the main memory 102 or the storage device 103, and performs stereoscopic display.

In a case where a candidate point switching operation and an attention region changing instruction are not input (No in step S215, and No in step S209), a series of stereoscopic image generation and display processes are finished.

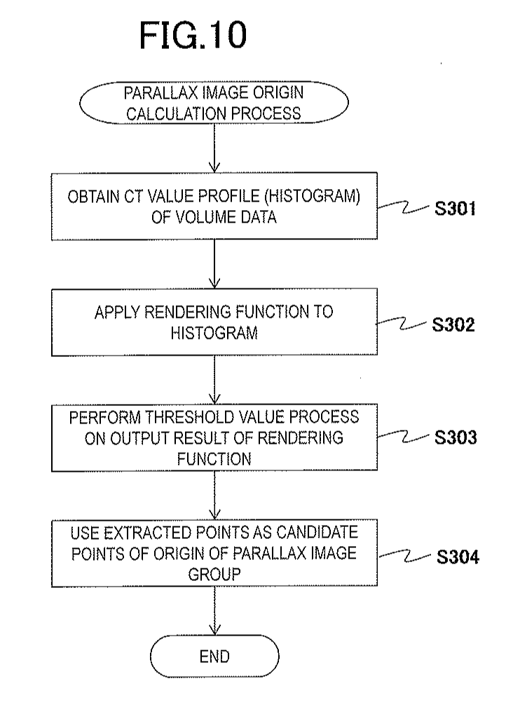

Next, with reference to FIG. 10, a description will be made of the parallax image origin calculation process in step S204.

When the parallax image origin calculation process is started, a position (viewpoint) where an attention region is observed is set, and the attention region is set to be located at the center of a projection plane in either case of parallel projection and central projection. It is assumed that a rendering function for rendering a region of interest is selected, and is acquired from the storage device 103.

First, the CPU 101 obtains a profile regarding voxel values (CT values) of the processing target volume data 3 (step S301). The profile calculated in step S301 is a histogram regarding CT values.

Next, the CPU 101 applies the above-described rendering function to the histogram generated in step S301 (step S302), and performs a threshold value process on an output result of the rendering function by using a threshold value of the region of interest (step S303). In step S303, points which have CT values greater than the threshold value and are present in the attention region are used as candidate points of the origin of the parallax image group (step S304).

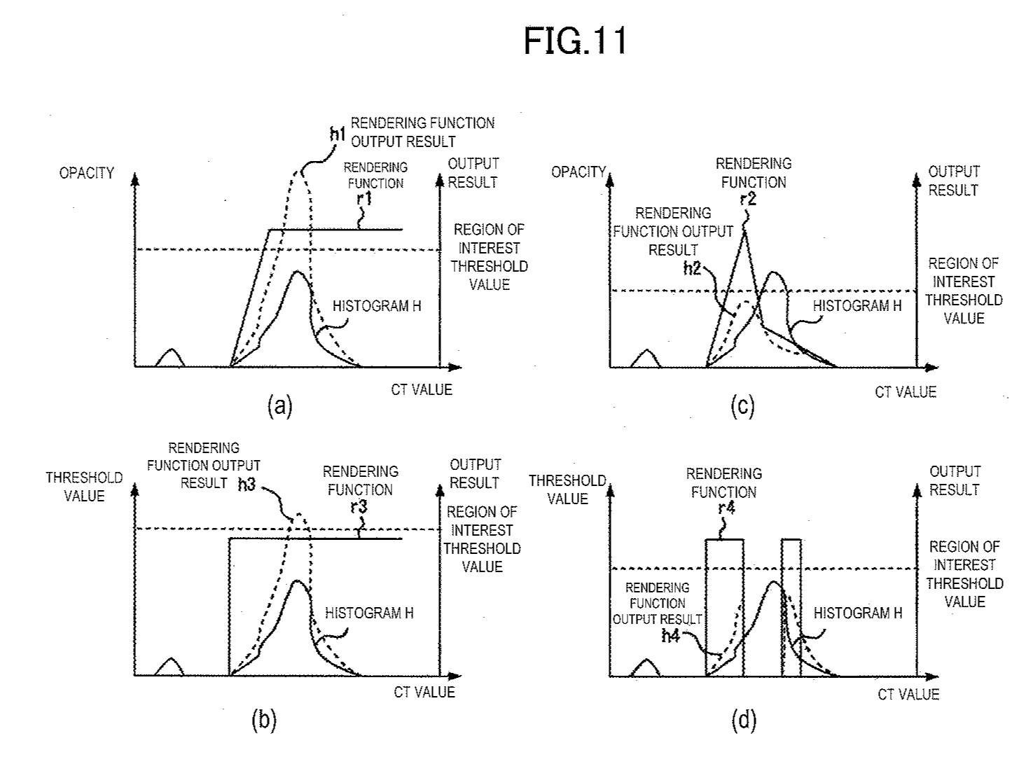

FIG. 11 is a diagram for explaining examples of applying the rendering function and the threshold value process in steps S302 and S303.

FIG. 11(a) illustrates an example in which a rendering function r1 for setting opacity of a part having a certain CT value or greater is applied to a histogram H. As illustrated in FIG. 11(a), if the rendering function r1 is applied to the histogram H calculated in step S301, a curve h1 indicated by a dashed line in FIG. 11(a) is obtained. A threshold value process for discriminating a region of interest from regions other than the region of interest is performed on the output result h1. The CPU 101 selects points having CT values greater than the threshold value from the inside of the attention region, and uses the points as candidate points of the origin.

FIG. 11(b) illustrates an example in which a rendering function r2 for setting opacity of a part having a CT value near a specific value is applied the histogram H. As illustrated in FIG. 11(b), if the rendering function r2 is applied to the histogram H calculated in step S301, a curve h2 indicated by a dashed line in FIG. 11(b) is obtained. A threshold value process for discriminating a region of interest from regions other than the region of interest is performed on the output result h2. The CPU 101 selects points having CT values greater than the threshold value from the inside of the attention region, and uses the points as candidate points of the origin.

FIG. 11(c) illustrates an example in which a rendering function r3 for rendering a part having a certain CT value or greater is applied to the histogram H. As illustrated in FIG. 11(c), if the rendering function r3 is applied to the histogram H calculated in step S301, a curve h3 indicated by a dashed line in FIG. 11(c) is obtained. A threshold value process for discriminating a region of interest from regions other than the region of interest is performed on the output result h3. The CPU 101 selects points having CT values greater than the threshold value from the inside of the attention region, and uses the points as candidate points of the origin.

FIG. 11(d) illustrates an example in which a rendering function r4 for rendering a part included in a range of two certain CT values is applied to the histogram H. As illustrated in FIG. 11(d), if the rendering function r4 is applied to the histogram H calculated in step S301, a curve h4 indicated by a dashed line in FIG. 11(d) is obtained. A threshold value process for discriminating a region of interest from regions other than the region of interest is performed on the output result h4. In the example illustrated in FIG. 11(d), there is no point exceeding the threshold value, and thus the origin is not calculated.

Meanwhile, the origin of the parallax image group is preferably set at an edge position of the region of interest. The CPU 101 may specify an edge position of the region of interest so as to set the edge position as an origin position in addition to the process in FIG. 10.

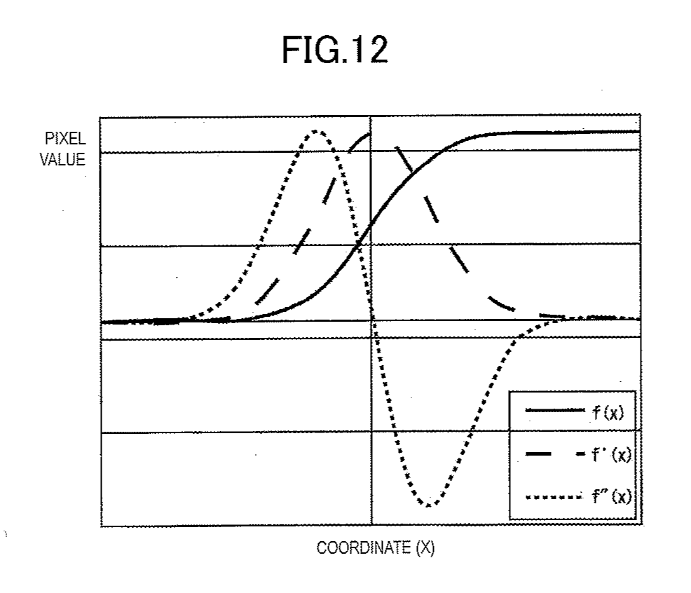

In an edge position calculation process described below, a certain model is assumed, and an edge part of the region of interest is determined. As the model, a boundary between two regions in which a pixel value smoothly transitions is considered. In FIG. 12, f(x) is a curve representing a change in a pixel value when a projection line crosses two regions, f′(x) is a curve representing a first order derivative at each position, and f″(x) is a curve representing a second order derivative. In FIG. 12, a transverse axis expresses coordinates on a straight line crossing the two regions, and a longitudinal axis expresses pixel values. In FIG. 12, a left region is a region in which a pixel value is small, a right region is a region in which a pixel value is great, and the center corresponds to a boundary between the two regions.

The CPU 101 specifies coordinates on the basis of a combination of the first order derivative f′(x) and the second order derivative f″(x) of pixel values, and determines how far a pixel is from an edge. If a function (hereinafter, referred to as an input function) representing a relationship between coordinates and an input-to-output ratio is used, an input-to-output ratio by which an edge emphasis filter is multiplied may be obtained via the input function by using coordinates which are calculated on the basis of a derivative value.

Hereinafter, a description will be made of an example in which the above-described model is represented by a numerical expression, and a coordinate x is derived from a combination of the first order derivative f′(x) and the second order derivative f″(x) of pixel values. If, of the two regions, a pixel value average of the region in which a pixel value is small is indicated by Vmin, a pixel value average of the region in which a pixel value is great is indicated by Vmax, and a width of the boundary is indicated by σ, a pixel value V at the coordinate x with the boundary as the origin may be expressed by the following Equation (1).

$$V = f ( x ) = {V}_{xsin} + ( {V}_{cosx} - {V}_{xsin} ) \frac{1 + g ( \frac{x}{σ \sqrt{2}} )}{2} \qquad ( 1 )$$

Here, an error function g is defined by the following Equation (2).

$$g ( x ) = \frac{2}{\sqrt{π}} {\int }_{0}^{x} exp ( - {t}^{2} ) dt \qquad ( 2 )$$

The first order derivative and the second order derivative of pixel values at the coordinate x are derived as in the following Equations (3) and (4) according to Equations (1) and (2).

$$\begin{matrix}{f}^{′} ( x ) = \frac{{V}_{cosx} - {V}_{xsin}}{σ \sqrt{2 π}} exp ( - \frac{{x}^{3}}{2 {σ}^{2}} ) & ( 3 ) \\ {f}^{″} ( x ) = - \frac{x ( {V}_{cosx} - {V}_{xsin} )}{{σ}^{3} \sqrt{2 π}} exp ( - \frac{{x}^{2}}{2 {σ}^{2}} ) & ( 4 )\end{matrix}$$

The coordinate x is derived as in Equation (5) by using the first order derivative and the second order derivative.

$$x = - {σ}^{2} \frac{{f}^{″} ( x )}{{f}^{′} ( x )} \qquad ( 5 )$$

In the edge emphasis filter, an average value of the first order derivative and an average value of the second order derivative of respective pixel values in a single image are obtained, and a coordinate of each pixel value is obtained by using the average values according to Equation (5). An average coordinate p(V) obtained for the pixel value V in a certain image is expressed by Equation (6).

$$p ( V ) = - {σ}^{2} \frac{h ( V )}{g ( V )} \qquad ( 6 )$$

Here, the pixel value g(V) is an average value of the first order derivative at the pixel value V, and h(V) is an average value of the second order derivative at the pixel value V.

The coordinate x obtained according to Equation (5) is converted into an input-to-output ratio by using the above-described input function. If the input function for the coordinate x is indicated by P(x), an input-to-output ratio α(V) allocated to the pixel value V is expressed by Equation (7).

α(V)=β(p(V)) (7)

A result of the edge emphasis filter α(V) obtained in the above-described manner being multiplied by the rendering function prepared by the operator is used in the rendering process, and thus a rendering image in which an edge is emphasized can be obtained. The CPU 101 can specify an edge position of the region of interest by calculating a coordinate of an emphasized pixel value present on the projection line in the rendering process.

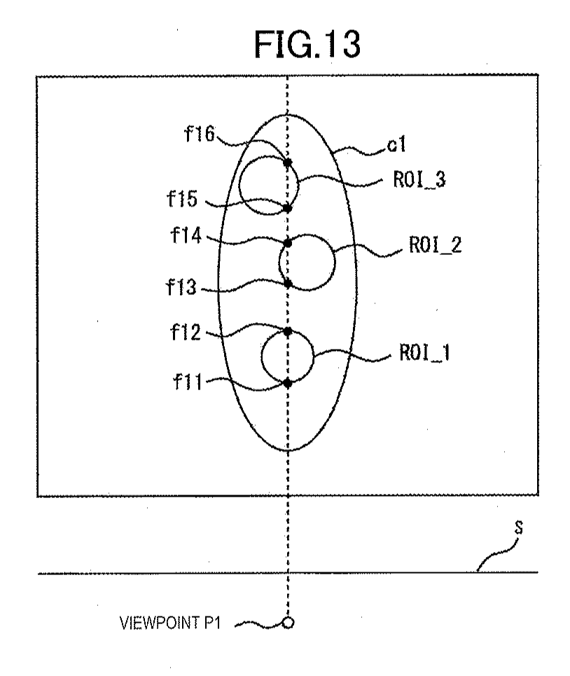

For example, as illustrated in FIG. 13, edge positions of regions of interest ROI_1, ROI_2 and ROI_3 which are present in the attention region c1 may be specified, and the respective edge positions may be used as positions of candidate points f11 to f16 of the origin.

The first parallax image group generation portion 25 is notified of the candidate points of the origin of the parallax image group, obtained through the above-described parallax image group origin calculation process, and a parallax image group having each candidate point as the origin is generated in step S205 in FIG. 9. Through the processes in steps S206 to S208, the candidate points are switched, and stereoscopic images based on parallax image groups obtained for the respective candidate points are switched and displayed.

According to the parallax image origin calculation process in FIG. 10, in a case where an attention region is rendered from a predetermined viewpoint direction, points corresponding to several regions of interest present in the attention region may be used as the origin of a parallax image group.

Next, with reference to FIG. 14, a description will be made of the focal point position candidate point calculation process in step S210.

Also in the focal point position calculation process, in the same manner as in the parallax image origin calculation process (FIG. 10), first the CPU 101 obtains a profile (histogram) regarding CT values of the processing target volume data 3 (step S401), applies a predetermined rendering function to the histogram (step S402), and performs a threshold value process on an output result of the rendering function by using a threshold value of the region of interest (step S403). In step S403, a plurality of points (representative points) which have CT values greater than the threshold value and are present in the attention region are extracted.

Next, positions of the plurality of representative points extracted in step S403 are moved to a stereoscopic central line L in a state in which positions in a depth direction when viewed from the viewpoint are fixed (step S404). The stereoscopic central line L is a perpendicular line which extends to the projection plane S from the origin O1 of the first parallax image group. The CPU 101 uses respective points as a result of moving the representative points, as candidate points for the second focal point position (step S405).

The second parallax image group generation portion 28 is notified of the candidate points for the second focal point, obtained through the above-described focal point position calculation process. A visual angle is set in step S211 in FIG. 9, and a parallax image group having each candidate point as a focal point is generated in step S212. Through the processes in steps S213 to S215, the candidate points are switched, and stereoscopic images based on parallax image groups obtained for the respective candidate points are switched and displayed.

According to the focal point position calculation process in FIG. 14, in a case where an attention region is rendered from a predetermined viewpoint direction, points whose depth direction positions are the same as those of representative points in several regions of interest present in the attention region and which are moved to the stereoscopic central line L of the original stereoscopic images (first parallax image group) may be obtained as candidate points for a focal point position.

In the same manner as in the above-described parallax image origin calculation process (FIG. 10), when candidate points for a focal point position is calculated, the focal point position is preferably calculated so that an edge vicinity of a region of interest present in an attention region is focused on.

As described above, according to the image processing apparatus 100 of the second embodiment, the CPU 101 can automatically calculate which point in an attention region is used as the origin or a focal point position, generate stereoscopic images by using a plurality of candidate points, and display the stereoscopic images in a switching manner. Therefore, the operator displays an optimal stereoscopic image while checking a difference of a viewing way of stereoscopic images in a case where each candidate point is used as a focal point (origin), and thus the stereoscopic image can be used for diagnosis. Since parallax image groups having the respective candidate points are generated and stored in advance before a timing of switching the candidate points, display of stereoscopic images can be switched immediately in response to a switching operation.

The image processing apparatus 100 of the second embodiment may be characterized in that the CPU 101 generates a profile regarding voxel values of the volume data, and calculates at least one point present in the attention region as candidate points of the origin of the first parallax image group on the basis of the generated profile and a rendering condition.

As mentioned above, since at least one point present in the attention region is calculated as candidate points of the origin on the basis of the generated profile regarding voxel vales of the volume data and a rendering condition, according to the focal point position calculation process, in a case where an attention region is rendered from a predetermined viewpoint direction, points whose depth direction positions are the same as those of representative points in several regions of interest present in the attention region and which are moved to the stereoscopic central line L of the original stereoscopic images (first parallax image group) may be obtained as candidate points for a focal point position.

The image processing apparatus 100 of the second embodiment may be characterized in that the main memory 102 or the storage device 103 which stores parallax image groups generated with respect to candidate points for the second focal point position is further provided, an instruction for switching the candidate points is input via the input device 109 or the mouse 108, and the CPU 101 reads parallax image groups for different candidate points from the main memory 102 or the storage device 103 in response to the instruction, and sequentially switches the parallax image groups so as to perform stereoscopic display.

As mentioned above, focal point positions are sequentially switched and displayed in response to an instruction from the operator, and thus the operator can determine a focal point position while checking a difference in a viewing way.

The image processing apparatus 100 of the second embodiment may be characterized in that an instruction for switching whether a visual angle is fixed and stereoscopic display is performed, or a visual angle is changed and stereoscopic display is performed is input via the input device 109 or the mouse 108, the CPU 101 generates the second parallax image group at the same visual angle as a visual angle set when the first parallax images are generated, generates the second parallax image group at a visual angle corresponding to a distance between the second focal point position and the viewpoint, stores the second parallax image group in the main memory 102 or the storage device 103, reads parallax image groups for different set visual angles from the main memory 102 or the storage device 103 in response to an instruction from the input device 109 or the mouse 108, and displays the parallax image groups in a switching manner.

As mentioned above, since, regarding generation of the second parallax image group, the second parallax image group is generated at the same visual angle as a visual angle set when the first parallax images are generated, and the second parallax image group is generated at a visual angle corresponding to a distance between the second focal point position and the viewpoint, setting of a visual angle is omitted when the second parallax image group is generated, and thus the number of the operator's operating the input device 109 or the mouse 108 can be reduced, which contributes to improvement of operability.

### Third Embodiment

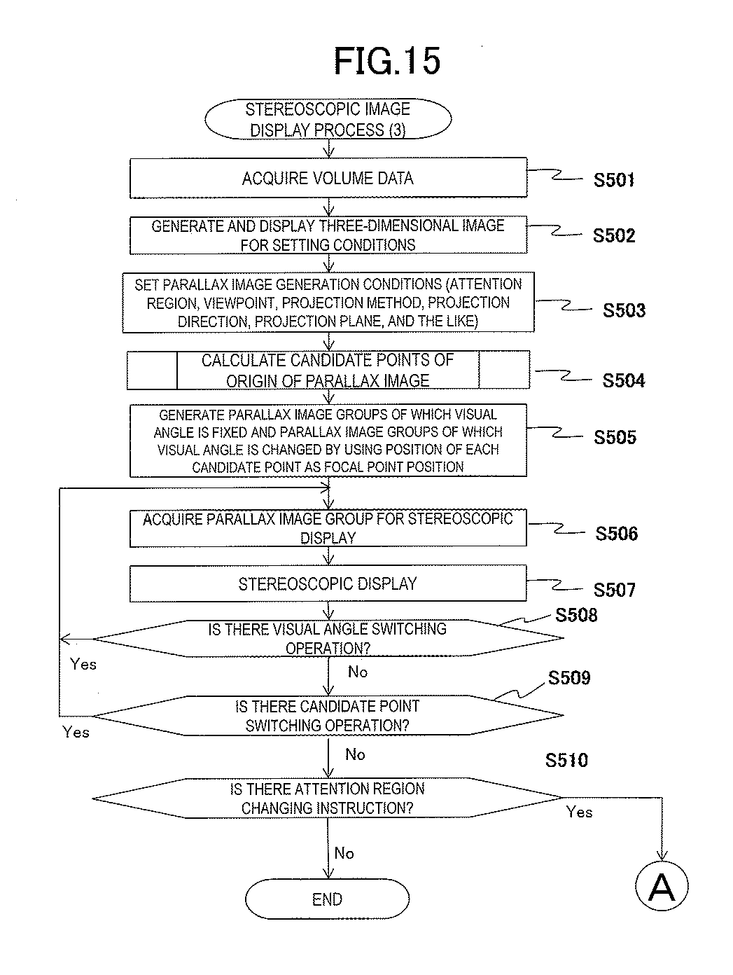

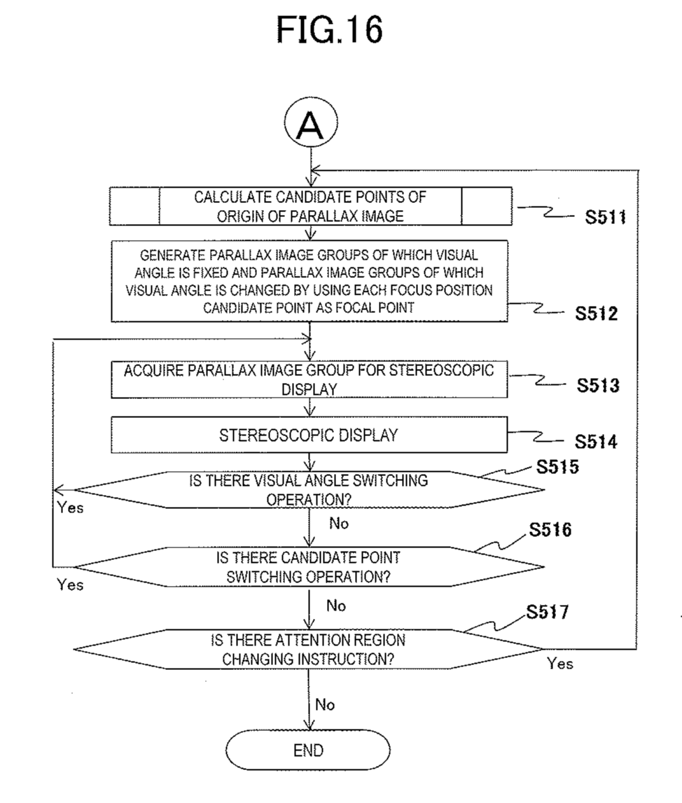

Next, a third embodiment of the present invention will be described with reference to FIGS. 15 and 16.

The image processing apparatus 100 of the third embodiment has a configuration in which the operator can switch whether a visual angle which is set to be fixed in advance is used, or a visual angle which is calculated according to a distance between a viewpoint and a focal point position is used, in the stereoscopic image display process of the first embodiment or the second embodiment.

For this, the CPU 101 (the first parallax image group generation portion 25 and the second parallax image group generation portion 28) generates both of parallax image groups of which a visual angle is fixed and a visual angle is changed when generating the parallax image groups, and holds the parallax image groups in the main memory 102 or the storage device 103. If a visual angle switching operation is input by the operator in a case where a stereoscopic image of which a visual angle is fixed is displayed, a parallax image group of which a visual angle is changed is read from the main memory 102 or the storage device 103, and thus the display is updated. If a visual angle switching operation is input by the operator in a case where a stereoscopic image of which a visual angle is changed is displayed, the CPU 101 reads a parallax image group of which a visual angle is fixed from the main memory 102 or the storage device 103, and thus the display is updated.

A hardware configuration of the image processing apparatus 100 of the third embodiment is the same as that of the image processing apparatus 100 (refer to FIG. 1) of the first embodiment or the second embodiment, and a functional configuration is the same as that of the image processing apparatus 100 (refer to FIG. 4) of the first embodiment or the second embodiment except for the first parallax image group generation portion 25 and the second parallax image group generation portion 28, and thus repeated description will be omitted.

FIGS. 15 and 16 are flowcharts illustrating the entire flow of a stereoscopic image display process (3) in the third embodiment.

Steps S501 to S504 are the same as steps S201 to S204 in the second embodiment. The CPU 101 acquires processing target volume data of medical images from the image database 111 (step S501), generates a three-dimensional image for setting conditions, and displays the image on the display device 107 (step S502). The operator sets conditions for generating parallax images while rotating the three-dimensional image for setting conditions or moving the image in parallel (step S503). The conditions include an attention region, a viewpoint position, a range of a stereoscopic space, a rendering function, and the like.

Next, the CPU 101 calculates the origin of the first parallax image group g1 on the basis of the conditions set in step S502 (step S504). In step S504, for example, in the same manner as in the origin calculation process of the second embodiment (refer to FIG. 10), the CPU 101 calculates a plurality of candidate points of the origin of the first parallax image group g1 from the inside of the attention region c1.

The CPU 101 generates the parallax image groups g1, g12, g13, . . . so that the respective candidate points of the origin calculated in step S504 are located at the focal point positions f11, f12, f13, . . . (step S505).

In the parallax image group generation process in step S505, the CPU 101 calculates parallax image groups g11A, g12A, g13A, . . . of which a visual angle is fixed, and also calculates parallax image groups g11B, g12B, g13B, . . . of which a visual angle is changed depending on a focal point position. In a case where a visual angle is fixed, for example, as illustrated in FIG. 6, a viewpoint position is finely adjusted so that visual angles (θ1-1 and θ2-1) for right eye parallax images are made to be the same as each other, and a rendering process is performed, even if focal point positions are different from each other.

Similarly, with respect to left eye parallax images, a viewpoint position is finely adjusted so that visual angles (θ1-2 and θ2-2) for the left eye parallax images are made to be the same as each other, and a rendering process is performed, even if focal point positions are different from each other.

On the other hand, in a case where a visual angle is changed, visual angles of respective parallax image groups are calculated on the basis of distances between the respective focal points f11, f12, f13, . . . and the viewpoints P1 and P2, and the parallax image groups g11B, g12B, g13B, . . . are generated at the calculated visual angles.

In a case where a visual angle is fixed, and a depth direction position of a focal point is changed, stereoscopic images showing different unevennesses can be displayed without changing forms of the images. On the other hand, in a case where a visual angle is changed in accordance with a depth direction position of a focal point, an object close to the viewpoint stands out and protrudes, and thus forms of the images slightly change. A viewing way of a stereoscopic image differs due to a difference in a set visual angle, but visual angle fixation and visual angle changing may be selected according to a preference of the operator.

The CPU 101 stores the generated parallax image groups g11A, g11B, g12A, g12B, g13A, g13B, . . . in the main memory 102 or the storage device 103.

The CPU 101 reads a single parallax image group among the plurality of generated parallax image groups (step S506), and performs stereoscopic display (step S507). For example, in the parallax image groups g11 having, as a focal point among the plurality of parallax image groups, the candidate point f11 which is nearest to the viewpoint, the parallax image group g11A of which a visual angle is fixed is acquired, and the stereoscopic display is performed.

If a visual angle switching operation is input (Yes in step S508), the CPU 101 acquires the parallax image group g11B of which a focal point position is the same as that of the original parallax image group and a visual angle is changed (step S506), and performs stereoscopic display (step S507).

If a candidate point switching operation is input (Yes in step S509), a parallax image group which has another focal point and of which a visual angle is the same as a set visual angle when the candidate point switching operation is input is acquired (step S506), and stereoscopic display is performed (step S507). For example, since the parallax image group g11B of which a visual angle is changed when the candidate point switching operation is input, the CPU 101 acquires the parallax image group g12B of which a visual angle is changed among the parallax image groups having the focal point position f12 which is second nearest to the viewpoint, and performs stereoscopic display. As mentioned above, whenever a visual angle switching operation is input, the CPU 101 alternately switches parallax image groups of which a visual angle is fixed or changed. Whenever the candidate point switching operation is input, a parallax image group at the next depth direction position is read from the main memory 102 or the storage device 103, and stereoscopic display is performed.

In a case where an attention region changing instruction is input (Yes in step S510), the CPU 101 calculates candidate points for a focal point position from the inside of the attention region c2 after being changed (step S511 in FIG. 16). The candidate points for a focal point position are calculated through, for example, the focal point position calculation process (refer to FIG. 14) of the second embodiment.

Next, the CPU 101 generates the parallax image groups g21, g22, g23, . . . by using respective candidate points f21, f22, f23, . . . for a focal point position calculated in step S511 as focal points (step S512).

In the parallax image group generation process in step S512, the CPU 101 calculates parallax image groups g21A, g22A, g23A, . . . of which a visual angle is fixed, and also calculates parallax image groups g21B, g22B, g23B, . . . of which a visual angle is changed.

The CPU 101 stores the generated parallax image groups g21A, g21B, g22A, g22B, g23A, g23B, . . . in the main memory 102 or the storage device 103.

The CPU 101 reads a single parallax image group among the plurality of generated parallax image groups (step S513), and performs stereoscopic display (step S514). For example, among the plurality of parallax image groups, the parallax image group g21A which has a focal point position nearest to the viewpoint and of which a visual angle is fixed is acquired, and the stereoscopic display is performed.

If a visual angle switching operation is input (Yes in step S515), the CPU 101 acquires the parallax image group g21B of which a focal point position is the same as that of the original parallax image group g21A and a visual angle is changed (step S513), and performs stereoscopic display (step S514).

If a candidate point switching operation is input (Yes in step S516), a parallax image group having another focal point is acquired (step S513), and stereoscopic display is performed (step S514). As a visual angle, a set visual angle when the candidate point switching operation is input is used. For example, since the parallax image group g21B of which a visual angle is changed is displayed when the candidate point switching operation is input, the CPU 101 acquires the parallax image group g22B of which a visual angle is changed of the parallax image groups g22A and g22B having the focal point position f22 which is second nearest to the viewpoint, and performs stereoscopic display. As mentioned above, whenever a visual angle switching operation is input, the CPU 101 alternately switches parallax image groups of which a visual angle is fixed or changed. Whenever the candidate point switching operation is input, a parallax image group at the next depth direction position is read from the main memory 102 or the storage device 103, and stereoscopic display is performed.

In a case where an attention region changing instruction is input (Yes in step S517), the flow returns to step S511, and the processes in steps S511 to S516 are repeatedly performed. In a case where a visual angle switching operation, a candidate point switching operation, and an attention region changing instruction are not input (No in step S515, No in step S516, and Yes in step S517), a series of stereoscopic image display processes (3) are finished.

As described above, in the image processing apparatus 100 of the third embodiment, the operator can freely switch whether an original visual angle is used (visual angle fixation) or a visual angle calculated on the basis of a viewpoint and a focal point position is used (visual angle changing), when parallax image groups having different focal point positions are stereoscopically displayed.

A stereoscopic image being convenient to view in which case of visual angle fixation and visual angle changing differs depending on an operator or an observation target. Thus, since visual angle setting can be selected, stereoscopic display can be performed at an optimal visual angle corresponding to an operator's taste, and a stereoscopic image which is convenient for more operators to observe can be provided.

In the third embodiment, there is a configuration in which an operator can switch visual angle fixation and visual angle changing in a case where a focal point position is changed, but there may be a configuration in which several parallax image groups of which only a visual angle is changed are generated, and are switched and displayed, even in a case where a focal point position is not changed.

If a visual angle is changed without changing a focal point position, stereoscopic images having different unevennesses can be displayed, and thus there may be a configuration in which an operator can select a favorite visual angle (unevenness).

In the above-described embodiments, a description has been made of an example in which the image processing apparatus 100 is connected to the image scanning apparatus 112 via the network 110, but the image processing apparatus 100 may be provided in the image scanning apparatus 112 so as to function.

As mentioned above, the preferred embodiments of the image processing apparatus and the like according to the present invention have been described with reference to the accompanying drawings, but the present invention is not limited to these examples. It is apparent that a person skilled in the art can conceive of various modifications or alterations within the scope of the technical spirit disclosed in the present application, and it is understood that they naturally fall within the technical scope of the present invention.

### REFERENCE SIGNS LIST

1 IMAGE PROCESSING SYSTEM, 100 IMAGE PROCESSING APPARATUS, 101 CPU, 102 MAIN MEMORY, 103 STORAGE DEVICE, 104 COMMUNICATION I/F, 105 DISPLAY MEMORY, 106a AND 106b I/F, 107 DISPLAY DEVICE, 108 MOUSE, 109 INPUT DEVICE, 110 NETWORK, 111 IMAGE DATABASE, 112 IMAGE SCANNING APPARATUS, 114 INFRARED EMITTER, 115 SHUTTER GLASSES, 21 VOLUME DATA ACQUISITION UNIT, 22 CONDITION SETTING UNIT, 23 PARALLAX IMAGE GROUP GENERATION UNIT, 24 FIRST FOCAL POINT POSITION CALCULATION PORTION, 25 FIRST PARALLAX IMAGE GROUP GENERATION PORTION, 26 ATTENTION REGION CHANGING UNIT, 27 SECOND FOCAL POINT POSITION CALCULATION PORTION, 28 SECOND PARALLAX IMAGE GROUP GENERATION PORTION, 29 STEREOSCOPIC DISPLAY CONTROL UNIT, F1 FIRST FOCAL POINT (PARALLAX IMAGE ORIGIN O1), f11 AND f12 ORIGIN CANDIDATE POINT, F2 SECOND FOCAL POINT, f21 AND f22 CANDIDATE POINT OF SECOND FOCAL POINT, g1 FIRST PARALLAX IMAGE GROUP, g2 SECOND PARALLAX IMAGE GROUP, P1 AND P2 VIEWPOINT, c1 AND c2 ATTENTION REGION, L STEREOSCOPIC CENTRAL LINE, θ VISUAL ANGLE, ROI_1 AND ROI_2 REGION OF INTEREST

1. An image processing apparatus comprising:
an input unit that receives setting of conditions including an attention region, a viewpoint position, a range of a stereoscopic space, and a rendering function used to generate a stereoscopic image, setting of a first attention region based on the conditions, and input values for setting a second attention region in a region which is different from the first attention region; and
a processing unit that calculates a first focal point position in the first attention region on the basis of the conditions, generates the first parallax image group from the first focal point position by using volume data which is obtained from an image scanning apparatus, calculates a second focal point position which is located on a stereoscopic central line set when the first parallax image group is generated and which is the same depth direction position as a position of a point in the second attention region, generates a second parallax image group from the second focal point position, and generates stereoscopic images by using the first parallax image group and the second parallax image group.

2. The image processing apparatus according to claim 1,
wherein a three-dimensional position of the volume data is further designated via the input unit, and
wherein the processing unit designates a point in the second attention region by using the three-dimensional position.

3. The image processing apparatus according to claim 1,
wherein the processing unit extracts a region of interest from the second attention region, calculates at least one representative point of the extracted region of interest, and uses, as candidate points for the second focal point position, respective points which are located on the stereoscopic central line set when the first parallax image group is generated and which are located at the same depth direction position as a position of each of the representative points.

4. The image processing apparatus according to claim 3,
wherein the processing unit extracts the region of interest on the basis of a profile regarding voxel values of the volume data and a rendering condition.

5. The image processing apparatus according to claim 3,
wherein the processing unit calculates an edge part of the region of interest as the representative point.

6. The image processing apparatus according to claim 3, further comprising:
a storage unit that stores parallax image groups generated with respect to candidate points for the second focal point position,
wherein the input unit provides an instruction for switching the candidate points, and
wherein the processing unit reads parallax image groups for different candidate points from the storage unit in response to the instruction, and sequentially switches the parallax image groups so as to perform stereoscopic display.

7. The image processing apparatus according to claim 1,
wherein the processing unit generates a profile regarding voxel values of the volume data, and calculates at least one point present in the attention region as candidate points of the origin of the first parallax image group on the basis of the generated profile and a rendering condition.

8. The image processing apparatus according to claim 7, further comprising:
a storage unit that stores parallax image groups generated with respect to candidate points for the second focal point position,
wherein the input unit provides an instruction for switching the candidate points, and
wherein the processing unit reads parallax image groups for different candidate points from the storage unit in response to the instruction, and sequentially switches the parallax image groups so as to perform stereoscopic display.

9. The image processing apparatus according to claim 1,
wherein the processing unit generates the second parallax image group at the same visual angle as a visual angle set when the first parallax image group is generated.

10. The image processing apparatus according to claim 1,
wherein the processing unit generates the second parallax image group at a visual angle corresponding to a positional relationship between the second focal point position and each viewpoint position.

11. The image processing apparatus according to claim 1,
wherein the input unit provides an instruction for switching whether a visual angle is fixed and stereoscopic display is performed, or a visual angle is changed and stereoscopic display is performed,
wherein the processing unit further includes the storage unit that generates the second parallax image group at the same visual angle as a visual angle set when the first parallax image group is generated, and generates and stores the second parallax image group at a visual angle corresponding to a distance between the second focal point position and the viewpoint, and
wherein the processing unit reads parallax image groups for different set visual angles from the storage unit in response to an instruction from the input unit, and displays the parallax image groups in a switching manner.

12. An image processing apparatus comprising:
a condition setting unit that sets conditions for generating stereoscopic images by using volume data obtained from an image scanning apparatus;
a first focal point position calculation portion that sets an origin of a parallax image group in a predetermined attention region on the basis of the conditions set by the condition setting unit, and uses a position of the origin as a first focal point position;
a first parallax image group generation portion that generates a first parallax image group by using the volume data so that the first focal point position is focused on;
an attention region changing unit that sets a second attention region in a region which is different from the attention region;
a second focal point position calculation portion that calculates, as a second focal point position, a position of a point which is located on a stereoscopic central line set when the first parallax image group is generated and which has the same depth direction position as a position of a point in the second attention region set by the attention region changing unit;
a second parallax image group generation portion that generates a second parallax image group by using the volume data so that the second focal point position is focused on; and
a stereoscopic display control unit that performs stereoscopic image display control by using the first parallax image group or the second parallax image group.

13. A stereoscopic display method of generating stereoscopic images, the method comprising:
a step of causing a processing unit to acquire volume data obtained from an image scanning apparatus;
a step of setting conditions for generating stereoscopic images;
a step of setting an origin of a parallax image group in a predetermined attention region on the basis of the set conditions, and using a position of the origin as a first focal point position;
a step of generating a first parallax image group by using the volume data so that the first focal point position is focused on;
a step of setting a second attention region in a region which is different from the attention region;
a step of calculating, as a second focal point position, a position of a point which is located on a stereoscopic central line set when the first parallax image group is generated and which has the same depth direction position as a position of a point in the second attention region;
a step of generating a second parallax image group by using the volume data so that the second focal point position is focused on; and
a step of performing stereoscopic image display control by using the first parallax image group or the second parallax image group.
